(19) United States
(12) Patent Application Publication
(10) Pub. No.: US 2005/0070280 A1
(43) Pub. Date: Mar. 31, 2005

(54) Access network selection apparatus and method in a heterogeneous system

(76) Inventors: Je-Hyun Jung, Suwon-si (KR); Sang-Do Lee, Suwon-si (KR); Joon-Ho Park, Seongnam-si (KR); Jin-Man Kim, Yongin-si (KR); Tae-Won Kim, Yongin-si (KR); Young-ki Jeon, Hwaseong-gun (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/948,201

(22) Filed: Sep. 24, 2004

(30) Foreign Application Priority Data
Sep. 26, 2003 (KR) 2003-67083

(51) Int. Cl. H04Q 7/20

(52) U.S. Cl. 455/434; 455/452.1

(57) ABSTRACT

An apparatus and method for connecting to one of different types of access networks in a heterogeneous network system in which the access networks overlap each other. The apparatus and method include attempting to connect to one of said one or more access networks according to a preset priority and receiving a communication service through the access network when a connection to the access network is successful; and attempting to connect to an access network having a next priority according to the preset priority when the connection to the access network is unsuccessful.

### PRIORITY

This application claims the benefit under 35 U.S.C. 119(a) of an application entitled “Access network selection method in heterogeneous system” filed in the Korean Intellectual Property Office on Sep. 26, 2003 and assigned Ser. No. 2003-67083, the entire contents of which are incorporated herein by reference.

### BACKGROUND OF THE INVENTION

1. Field of the Invention

The present invention relates to a network access apparatus and method in a mobile communication system. More particularly, the present invention relates to an optimal access network selection apparatus and method in network environments in which various access networks overlap each other.

2. Description of the Related Art

Mobile communication systems have developed from voice service-centered systems of the 1^{st} and the 2^{nd} generation through a circuit network to International Mobile Telecommunications (IMT)-2000 systems which are the 3^{rd} generation digital mobile communication systems. In a mobile telephone system until now, each country has employed a scheme such as a Global System for Mobile Communications (GSM) scheme of Europe, a Personal Digital Cellular (PDC) scheme of Japan, and a Time Division Multiple Access (TDMA) scheme and a Code Division Multiple Access (CDMA) scheme of North America and has provided each service. In order to unify such different schemes, an international mobile telecommunicaiton-2000 (‘IMT-2000’), which is a single standard, has been introduced. Further, a service has been provided through the IMT-2000. Such an IMT-2000 system provides a packet data service through which subscribers can connect to a wireless Internet in wide mobile communication environments, in contrast with the 1^{st} and the 2^{nd} generation mobile communication system. In the case of CDMA2000 1x of an IMT-2000 system, a subscriber connecting to an Internet protocol (‘IP’) network via a wireless access network can receive a maximum data service of 153.6 Kbps. Further, in the case of CDMA2000 1x EV-DO of the IMT-2000 system, a subscriber can receive a maximum data service of about 2.4 Mbps.

In a single scheme as described above, as each country has agreed to the multi-mode standard (IMT-2000), each country has competed for various types of uses with each other. Further, as a service gradually changes from a voice-centered service to a data-centered service and the number of users increases, a CDMA scheme having a high frequency efficiency has been largely highlighted. Furthermore, interest in a wireless LAN having a wider variety of bandwidths has largely increased.

Recently, keeping pace with the development of mobile communication environments as described above, various wireless access technologies such as wireless Local Area Networks (LANs) based on an IEEE 802.1 1x, hiperLAN/2, bluetooths have emerged. Even though such technologies do not guarantee mobility equal to that in a cellular mobile communication system, the technologies have been proposed as an alternative for providing a high speed data service while substituting for a fixed network such as a cable modem or a X Digital Subscriber Line (XDSL) in a hot spot containing a public place, a school, etc., or home network environments. For instance, a wireless LAN conforming to an IEEE 802.11b standard provides a transmission speed of about 11 Mbps in a 2.4 GHz ISM band. Further, a wireless LAN conforming to an IEEE 802.11a standard can provide not only a maximum transmission speed of 54 Mbps in a 5 GHz band but also a high speed wireless data service at a low cost.

Such wireless access technology has a high transmission speed. However, when a high speed data service is provided through the wireless LAN, there is a limitation in providing a public network service due to electric wave interference as well as severely limited mobility and low service coverage. In order to overcome such a limitation, the wireless access technology has developed into a wireless MAN technology having associated merits/demerits of the cellular mobile communication system and the wireless LAN. A high speed portable Internet (‘HPi’) system, which is employed as one example of such a wireless MAN technology and operates at a 2.3 GHz band, can provide each cell with a capacity of 50 Mbps in outdoor/indoor non-mobile environments and mobile environments with a walking speed and a medium/low speed (about 60 Km/h) by means of various types of terminals. Further, the HPi system supports wide transmission speeds according to radio channel conditions.

Accordingly, when access technologies providing various transmission speeds and mobility in wireless environments are activated, it is necessary to provide a service capable of complementing merits/demerits of different technologies with each other and satisfying various requirements of users.

### SUMMARY OF THE INVENTION

Accordingly, the present invention has been made to solve the above-mentioned problems occurring in the prior art, and an object of the present invention is to provide an apparatus and method by which a mobile terminal communicating through various access networks detects an optimal network and effectively provides a subscriber with a service.

In order to accomplish the aforementioned object, according to one aspect of the present, there is provided an apparatus and method for connecting to one of different types of access networks by a mobile terminal in a heterogeneous network system in which the access networks overlap each other. The apparatus and method comprise attempting to connect to one of said one or more access networks according to a preset priority and receiving a communication service through the access network when a connection to the access network is successful; and attempting to connect to an access network having a next priority according to the preset priority when the connection to the access network is unsuccessful.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing the structure of a heterogeneous network according to an embodiment of the present invention;

FIGS. 2A and 2B are diagrams illustrating a method for selecting an optimal network in a heterogeneous system according to one embodiment of the present invention;

FIG. 3 is a diagram illustrating a method for selecting an optimal network in a heterogeneous system according to another embodiment of the present invention; and

FIG. 4 is a diagram illustrating a method for selecting an optimal network in a heterogeneous system according to another embodiment of the present invention;

### DETAILED DESCRIPTION OF THE PREFERRED EMBODIMENTS

Hereinafter, embodiments according to the present invention will be described with reference to the accompanying drawings. In the following description of the present invention, a detailed description of known functions and configuration incorporated herein will be omitted for conciseness.

The embodiments of the present invention provide a method in which a terminal selects an optimal access network in a heterogeneous network including various access networks (e.g., cellular mobile communication systems based on a Code Division Multiple Access/Wideband Code Division Multiple Access (CDMA/WCDMA), wireless Local Area Networks (LANs) based on an IEEE 802.11x, IEEE 802.16/20, High speed Portable Internet (Hpi), etc), so that a user can receive a service in optimal environments.

For this purpose, a terminal must acquire information on different types of access networks or an access network must provide information enabling a terminal to connect to an optimal network. Accordingly, the embodiments of the present invention include a description about a process by which a terminal detects a network from different types of networks in order to receive an optimal service and a process by which the terminal selects an optimal network.

Hereinafter, in order to achieve the scope of the present invention, a heterogeneous network will be described as an example, which provides communication environments enabling a terminal to connect to a random access network in an area in which a cellular mobile communication system such as a CDMA 2000 1x Evolution-Data Only (1x/1x EV-DO), an Universal Mobile Telecommunications System/General Packet Radio Service (UMTS/GPRS) and various wireless access networks such as a wireless Local Area Network/Metropolitan Area Network (LAN/MAN), High Performance Radio Local Area Network/2 (HIPERLAN/2), etc., overlap each other. In a network structure of an embodiment of the present invention, a packet service & mobility gateway (‘PSMG’) is added to network elements (Mobile Switching Centers (MSCs), Visitor Location Registers (VLRs), Home Location Registers (HLRs), Packet Data Service Networks (PDSNs), Access Points (Aps), etc) defined in the existing mobile communication system and a wireless LAN/MAN, thereby enabling a circuit network to inter-works with a packet network.

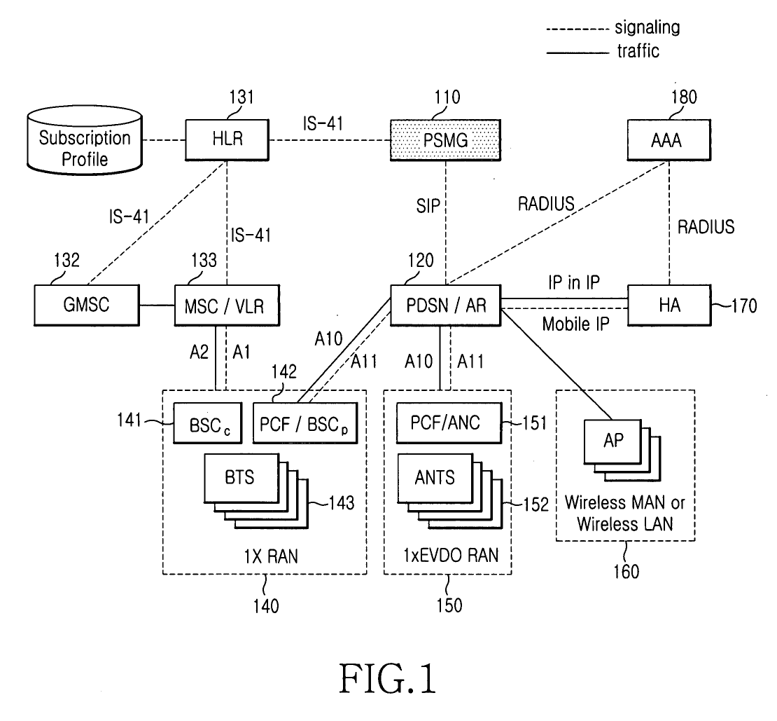

FIG. 1 is a block diagram illustrating the structure of a heterogeneous network according to an embodiment of the present invention. Herein, a packet data service node (‘PDSN’) inter-works with base transceiver stations in a CDMA 2000 1x network and a CDMA 2000 1x EV-DO network and an access router (‘AR’) inter-works with base transceiver stations in a wireless LAN network and a wireless MAN network. However, since the PDSN and the AR perform the same function, it is noted that the PDSN and AR are expressed by the term “PDSN/AR”. Hereinafter, even though the same reference numerals are used for convenience of description, the PDSN and the AR will be distinguished from each other and described according to networks with which the PDSN and the AR each inter-work.

The heterogeneous network includes the existing various access networks (e.g., CDMA 2000 1x/1x EV-DO networks and wireless LAN/MANs) and a Packet Service & Mobility Gateway (PSMG) 110 for providing an interworking service between a circuit network and a packet network to users connecting to a service network through the various access networks.

The PSMG 110 is connected between an IP network 130 of a user and an SS7 network 140. That is, the PSMG 110 is connected to the PDSN or the AR 120 and a Service Internet Protocol (SIP) server through a home location register (HLR) 131 and a SIP by means of a protocol based on the IS-41 standard. Further, the PSMG 110 performs a protocol conversion between the IS-41 and the SIP and manages connection states of a user and a mobile terminal through a location registration process from the mobile terminal and a SIP registration process from the PDSN/AR 120. Herein, the connection state of the mobile terminal managed by the PSMG 110 will be referred to as an “on packet” state and an “on circuit” state. Further, the PSMG 110 performs an SIP register function for performing position management for subscribers connecting to an IP network through the various access networks, and manages an interconnection relation of a Mobile Identification Number (MIN), an IP address, a Network Authentication Identifier (NAI) information, etc., on the basis of subscriber information received through the location registration process of the mobile terminal.

The home location register 131 connected to the PSMG 110 stores a service profile for a user connecting to a service network and provides mobile users with an automatic roaming service by performing a position management function, a state management function and an authentication function for a terminal and a subscriber on the basis of the service profile. Besides such general functions, the home location register 131 stores a service profile relating to a hybrid operation of a terminal such as incoming voice and data calls of a user connecting to a circuit network for the interworking service between the circuit network and the packet network. When an incoming call transmitted from a mobile terminal or a public switched telephone network (PSTN) is processed, the home location register 131 confirms whether the mobile terminal is a mobile terminal (‘HAT’) applied to the heterogeneous network. Herein, the type of mobile terminal is stored in the subscriber information. The HAT operates according to a procedure defined in the hybrid operation, thereby simultaneously providing a user with a circuit service and a packet service.

The PDSN or the AR 120 connected to the PSMG 110 through the SIP forms a two layer connection with the HAT through a point-to-point protocol (‘PPP’). Further, the PDSN or the AR 120 performs functions relating to an IP address assignment, an IP packet routing, a foreign agent (FA) function for a mobile IP service, an interworking with an authentication server 180 for accounting and authentication, quality of service (QoS), etc. Besides such general functions, the PDSN or the AR 120 performs the following functions in order to support the interworking service between the circuit network and the packet network.

When the HAT of a user having joined a simple IP service performs an SIP registration process, the PDSN or the AR 120 transmits a SIP registration message to the PSMG 110. When the HAT of a user having joined a mobile IP service performs a mobile IP registration process, the PDSN or the AR 120 transmits the SIP registration message to the PSMG 110. Further, whenever the HAT moves between the various access networks while holding a PPP connection with the PDSN or the AR 120, the PDSN or the AR 120 transmits the SIP registration message to the PSMG 110.

Further, when receiving an IP packet transmitted to a HAT in an on circuit state, the PDSN or the AR 120 performs a buffering for the IP packet before the HAT connects through a packet access network (AN). Furthermore, the PDSN or the AR 120 manages connection states of the user and the HAT through a SIP registration process or a mobile IP registration process from the HAT, and a notification process from the home location register 131. Herein, when the connection state of the HAT managed by the PDSN or the AR 120 is in a state communicating with a packet network, it will be referred to as an “on packet”. Further, when the connection state of the HAT managed by the PDSN or the AR 120 is in a state communicating with a circuit network, it will be referred to as an “on circuit”.

The authentication server 180 connects to the PDSN/AR 120 by means of a protocol such as a RADIUS or a DIAMETER and exchanges authentication and accounting information for the HAT and the user and subscriber information with the PDSN/AR 120. Further, the authentication server 180 stores a user profile relating to the hybrid operation of the HAT. Besides such network elements, since internal apparatuses of the wireless LAN/MAN network including a base transceiver station 140 in the CDMA 2000 1x network, a base transceiver station 150 in the CDMA 2000 1x EV-DO network and an access point (‘AP’) 160 are well known to those skilled in the art, a detailed description will be omitted. Further, since a MSC/VLR 133 and a Gateway Mobile Services Switching Center (GMSC) 132 connected to the CDMA 2000 1x network, and a home agent (HA) 170 connected to the wireless LAN/MAN network are well known to those skilled in the art, a detailed description will be omitted.

A location based services (LBS) (not shown) are services utilizing information on the position of a user using a predetermined information device, store information on the position of a HAT, and use the position information of the HAT in determining an exact position of a subscriber.

Hereinafter, a method for detecting and selecting an optimal access network on the system constructed as described above will be described.

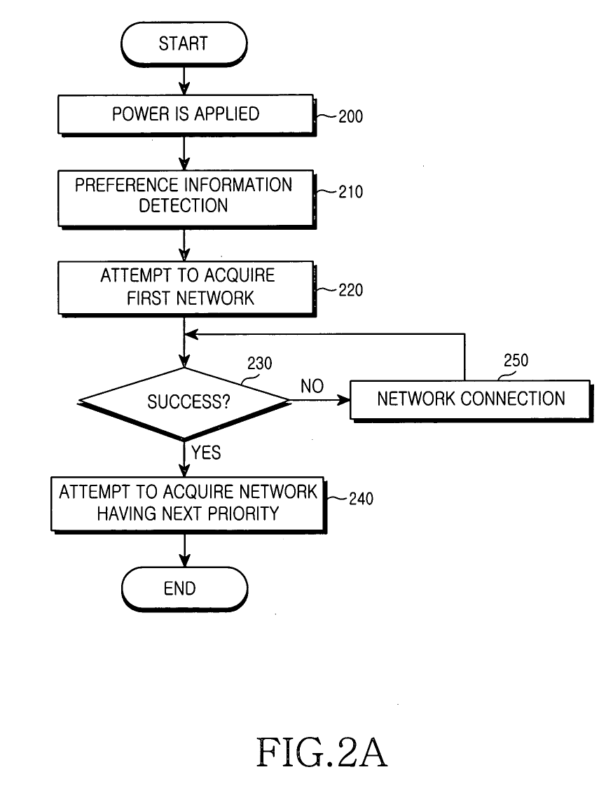

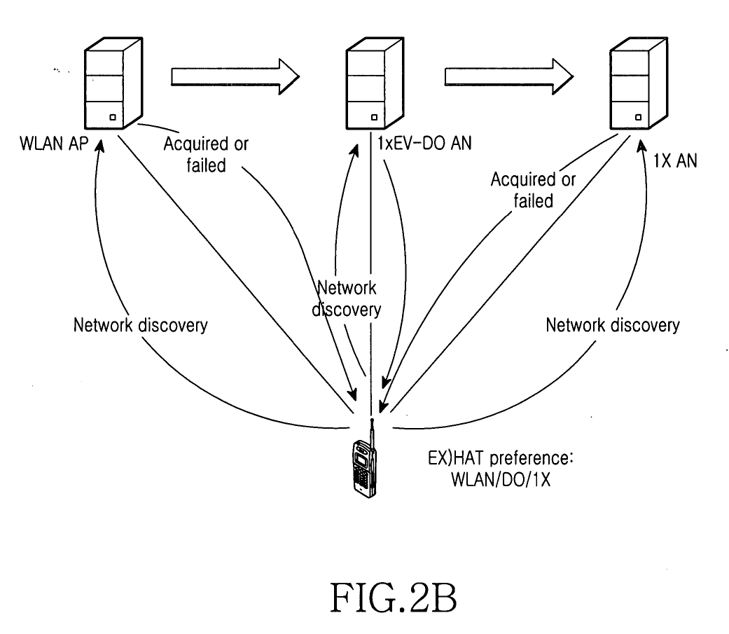

FIG. 2A is a flow diagram illustrating a method by which a HAT finds out and selects an access network system according to one embodiment of the present invention.

Referring to FIG. 2A, when the HAT is powered on in step 200, the HAT must receive a communication service after connecting to one of various types of access network systems. For this reason, the HAT automatically stores priority information between the access network systems according to a favorite service mainly used by a subscriber, or the HAT stores randomly set priorities when the preference of the subscriber is ambiguous. Further, when a preference is to be modified, the subscriber may adjust the priority for the preference through the HAT.

The HAT detects information on the priority in step 210 and attempts to select a network of the highest priority in step 220. FIG. 2B is a flow diagram illustrating a method by which the HAT selects a network when the preference of the HAT is set to be a sequence of a WLAN, a CDMA 2000 1x EV-DO network and a CDMA 2000 1x network in heterogeneous network environments including the WLAN, the CDMA 2000 1x EV-DO network and the CDMA 2000 1x network to which the HAT may connect. Referring to FIG. 2B, when the HAT attempts to select the WLAN because the WLAN has the highest priority.

In step 230, the HAT determines whether or not the network having the highest priority is selected . As a result of determination in step 230, when the HAT having succeeded in selecting the network having the highest priority, the HAT connects to the network having the highest priority and performs a communication service in step 240. In contrast, when the HAT has failed to select the network having the highest priority, the HAT attempts to select a network of a second priority in step 250. Referring to FIG. 2B, when the HAT attempts to select the CDMA 2000 1x EV-DO network because the CDMA 2000 1x EV-DO network has the second priority. Then, step 230 is repeated. According to the result of the determination in step 230, step 240 or step 250 is repeated. Referring to FIG. 2B, when the CDMA 2000 1x EV-DO network is selected, the HAT connects to the CDMA 2000 1x EV-DO network. In contrast, when the CDMA 2000 1x EV-DO network is not selected, the HAT attempts to selected a network of a third priority.

Meanwhile, when the HAT fails to select any one of multiple connectable networks by means of the afore-mentioned method and exists in an area in which the multiple networks overlap each other, the present invention includes another embodiment which provides for the HAT performing a call acquisition for an optimal network again. The embodiment includes two methods: a method by which an access network transmits cell information to the HAT and a method by which a core network provides the cell information.

Hereinafter, first, the method by which the access network transmits the cell information to the HAT will be described.

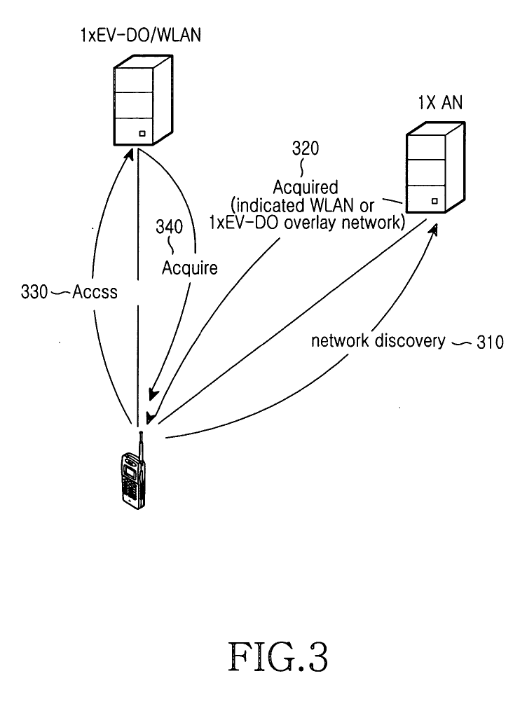

FIG. 3 is a view illustrating a method by which a HAT acquires an access network system according to another embodiment of the present invention.

Referring to FIG. 3, first, the HAT is powered on. Then, the HAT selects a system of a CDMA 1x AN in step 320 through a network discovery process in step 310. The selected access network transmits a Pseudo-random Noise (PN) value set to be a predetermined value in a dummy pilot signal to the HAT. Herein, the access network must adjust the intensity of the dummy pilot signal according to the coverage of a 1x EV-DO or a WLAN. When receiving the dummy pilot signal set to the predetermined PN value, the HAT is aware of the configuration of networks in an area in which various networks overlap each other through PN information promised in advance. Further, the HAT can determine whether or not the 1x EV-DO or the WLAN exists by means of the PN information. Accordingly, the HAT can change a network according to its own preference mode. Referring to FIG. 3, the HAT can perform a network change to the 1x EV-DO via steps 330 and 340.

As described above, the HAT having changed a mode to a 1x EV-DO mode or a WLAN mode by the information provided from the access network connects to the system and synchronizes with the 1x EV-DO or the WLAN.

Further, the access network may also transmit the configuration information of a current network to the HAT through a system parameter. Herein, the access network sets the system parameter so that an extended system parameter can be used in a system parameter message value.

For instance, the access network informs the HAT of overlapping of networks by adding three bits of current_network_supported field as shown in table 1 to a system parameter message.

TABLE 1

| Field | Length (bits) |
|---|---|
| Current_Network_Supported | 3 |

When the current_network_supported field has a value of 000 or 100, 101, 110, or 111, it represents a reserved field. When the current_network_supported field has a value of 001, it represents a state in which the HAT can connect to only the CDMA 1x. When the current_network_supported field has a value of 010, it represents a state in which the HAT can connect to both the CDMA 1x and the 1x EV-DO. When the current_network_supported field has a value of 011, it represents a state in which the HAT can connect to both the CDMA 1x and the WLAN.

The HAT determines the necessity of a mode change according to its own preference mode based on the value of the current_network_supported field and performs the mode change. As described above, the HAT having changed a mode to the 1x EV-DO mode or the WLAN mode by the information provided from the access network connects to the system and synchronizes with the 1x EV-DO or the WLAN.

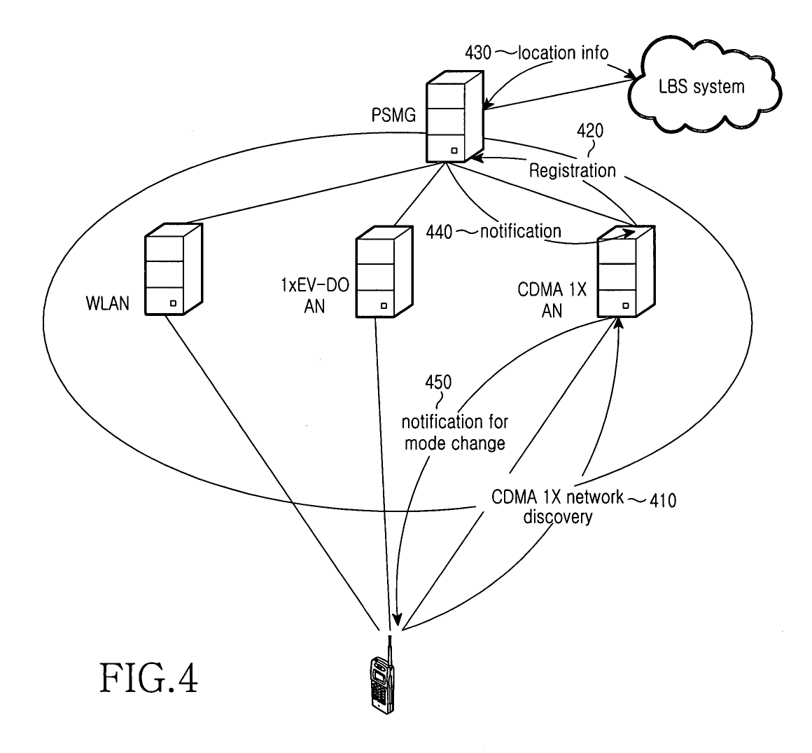

Next, the method by which the core network transmits the cell information to the HAT will be described with reference to FIG. 4.

Referring to FIG. 4, when the HAT selects a specific network after initially discovering networks by the preference of the HAT, a PSMG inter-works with a system aware of the exact position of the HAT. Herein, the PSMG provides information to the HAT so that the HAT can connect to the most optimal network through configuration information of the network.

The HAT connects to the CDMA 1x network by its own preference in step 410. Then, the CDMA lx network performs a registration for the PSMG 110 in step 420. Herein, the PSMG is aware of the position of the HAT through a LBS system in step 430 and information on overlapping information of a current network is selected through the awareness of the position of the HAT. Further, the PSMG transmits the network overlapping information to the corresponding HAT in step 440. A corresponding access network enables the HAT to change a mode through a service redirection message in step 450, and the HAT can change the mode to another mode according to its own preference mode.

As described above, when a network discovery and selection method of the present invention is used, an optimal network can be selected by the preference of a user regardless of the different types of networks such as cellular mobile communication networks and wireless LAN/MANs.

Further, according to an embodiment of the present invention, when a wireless data service is to be provided, a subscriber can receive the service through an optimal network according to environments to which the subscriber belongs. In particular, in the case of a high speed data service or a service requiring a high bandwidth, it is efficient to receive the service through a CDMA 2000 1x EV-DO in comparison to a CDMA 2000 1x. Additionally, it is further efficient to receive the service through a wireless LAN/MAN in comparison with the CDMA 2000 1x EV-DO. Accordingly, a data service can be transmitted/received to/from a corresponding network through environments through which a subscriber can receive the service most efficiently.

While the invention has been shown and described with reference to certain embodiments thereof, it should be understood by those skilled in the art that various changes in form and details may be made therein without departing from the spirit and scope of the invention as defined by the appended claims.

1. A method for connecting to one of different types of access networks by a mobile terminal in a heterogeneous network system in which the access networks overlap each other, the method comprising the steps of:
attempting to connect to one of said one or more access networks according to a preset priority and receiving a communication service through the access network when a connection to the access network is successful; and
attempting to connect to an access network having a next priority according to the preset priority when the connection to the access network is unsuccessful.

2. The method as claimed in claim 1, wherein the priority changes according to an input of a user.

3. A method for connecting to one of different types of access networks by a mobile terminal in a heterogeneous network system in which the access networks overlap each other, the method comprising the steps of:
a) connecting to one of said one or more access networks and receiving information on connectable access networks, which belong to an area in which said access networks overlap each other, from the access network to which the mobile terminal has connected; and
b) changing the currently connected access network to one of the connectable access networks according to a preset priority and connecting to the changed access network.

4. The method as claimed in claim 3, wherein step a) comprises a sub-step of receiving the information on the connectable access networks from the connected access network through a dummy pilot signal.

5. The method as claimed in claim 3, wherein the step a) comprises a sub-step of receiving the information on the connectable access networks from the connected access network through a value of a system parameter message containing a field indicating the connectable access networks.

6. An apparatus for connecting to one of different types of access networks in a heterogeneous network system in which the access networks overlap each other, comprising:
a memory adapted to store programs;
a keypad adapted to enter commands; and
a controller adapted to connect to one of said one or more access networks according to a preset priority and receive a communication service through the access network when a connection to the access network is successful, and attempt to connect to an access network having a next priority according to the preset priority when the connection to the access network is unsuccessful.

7. The apparatus as claimed in claim 6, wherein the priority changes according to an input of a user.

8. The apparatus of claim 6, wherein the apparatus comprises a mobile terminal.

9. An apparatus for connecting to one of different types of access networks in a heterogeneous network system in which the access networks overlap each other, comprising:
a memory adapted to store programs;
a keypad adapted to enter commands; and
a controller adapted to connect to one of said one or more access networks and receive information on connectable access networks, which belong to an area in which said access networks overlap each other, from the access network to which the apparatus has connected, and change the currently connected access network to one of the connectable access networks according to a preset priority and connect to the changed access network.

10. The apparatus as claimed in claim 9, wherein the apparatus is further adapted to receive the information on the connectable access networks from the connected access network through a dummy pilot signal.

11. The apparatus as claimed in claim 9, wherein the apparatus is further adapted to receive the information on the connectable access networks from the connected access network through a value of a system parameter message containing a field indicating the connectable access networks.

12. The apparatus of claim 9, wherein the apparatus comprises a mobile terminal.
